(19) United States
(12) Patent Application Publication
(10) Pub. No.: US 2017/0048094 A1
(43) Pub. Date: Feb. 16, 2017

(54) CHANNEL EQUALIZATION APPARATUS AND METHOD BASED ON PILOT SIGNALS FOR DOCSIS DOWN STREAM SYSTEM

(71) Applicant: ELECTRONICS AND TELECOMMUNICATIONS RESEARCH INSTITUTE, Daejeon (KR)

(72) Inventors: Jae Hwui BAE, Daejeon (KR); Sang Jung RA, Daejeon (KR); Jae Ho LEE, Daejeon (KR); Dong Joon CHOI, Daejeon (KR); Nam Ho HUR, Sejong (KR)

(21) Appl. No.: 15/211,360

(22) Filed: Jul. 15, 2016

(30) Foreign Application Priority Data
Aug. 10, 2015 (KR) 10-2015-0112298

(51) Int. Cl. H04L 27/26; H04L 12/28; H04L 5/00; H04L 25/02

(52) U.S. Cl. CPC H04L 27/2662; H04L 25/024; H04L 12/2801; H04L 5/0048

(57) ABSTRACT

An apparatus and a method of channel estimation and equalization based on pilot signals, which acquire a channel estimation vector and effectively perform channel equalization by using scattered pilots and continuous pilots in a communication system to which an OFDM symbol is applied, such as a DOCSIS 3.1 Down stream PHY system using multiple carriers.

### CROSS-REFERENCE TO RELATED APPLICATIONS

This application claims priority to and the benefit of Korean Patent Application No. 10-2015-0112298 filed in the Korean Intellectual Property Office on Aug. 10, 2015, the entire contents of which are incorporated herein by reference.

### BACKGROUND OF THE INVENTION

### 1. Field of the Invention

The present invention relates to an apparatus and a method of channel equalization based on pilot signals in a communication system to which an OFDM symbol is applied, and particularly, to an apparatus and a method of channel estimation and equalization based on a pilot, which acquires a channel estimation vector and effectively performs channel equalization by using scattered pilots and continuous pilots in a cable interface system such as a down stream physical (PHY) system of data over cable service specification (DOCSIS) 3.1 (standard interface for a cable modem) using multiple carriers.

### 2. Description of Related Art

A DOCSIS 3.1 Down Stream PHY system applies scattered pilots for channel equalization. When the conventional channel estimation and channel equalization method is applied to a DOCSIS 3.1 Down Stream receiver, a memory having a size of approximately 58 Mbits for storing 3 data having a length of 128 OFDM symbols is required. There is a big difficulty in implementing such a large memory in a receiving chip and the large memory also increases power consumption of the receiver.

Therefore, a new channel estimation and channel equalization method is required, which is applicable to the DOCSIS 3.1 Down stream system capable of overcoming a problem of the conventional channel estimation method.

### SUMMARY OF THE INVENTION

The present invention has been made in an effort to provide an apparatus and a method of channel estimation and equalization based on a pilot, which acquire a channel estimation vector and effectively perform channel equalization by using scattered pilots and continuous pilots in a communication system to which an OFDM symbol is applied, such as a DOCSIS 3.1 Down stream PHY system (briefly, a DOCSIS system or a cable interface system) using multiple carriers.

That is, the present invention has been made in an effort to provide an apparatus and a method of channel estimation and equalization based on a pilot of a DOCSIS system receiver, which can significantly enhance complexity in terms of hardware implementation compared to the related art because the hardware implementation is very simple while securing a capability sufficient to compensate for distortion which occurs in a cable transmission channel which is not almost changed depending on a time by reliable channel estimation through a channel estimation and channel equalization method optimized for scattered pilot and continuous pilot patterns of a DOCSIS system down stream.

The technical objects of the present invention are not limited to the aforementioned objects, and other technical objects, which are not mentioned above, will be apparently appreciated by a person having ordinary skill in the art from the following description.

An exemplary embodiment of the present invention provides a channel estimation and equalization method based on pilot signals, including: extracting subcarrier values at a scattered pilot location and a continuous pilot location for each OFDM symbol with respect to predetermined processing unit of OFDM symbols from an OFDM symbol where a preamble of a received signal of a communication system starts; calculating a channel estimation value acquired by dividing the scattered pilot subcarrier value at the scattered pilot location by a transmission scattered pilot subcarrier value to calculate a channel estimation vector constituted by an OFDM symbol channel estimation value for each processing unit of OFDM symbol; calculating a channel estimation vector constituted by channel estimation values at all subcarrier locations of a length of one OFDM symbol by using the OFDM symbol channel estimation value at the scattered pilot location and the channel estimation value at the continuous pilot location included in any one OFDM symbol; and performing channel equalization by dividing a received OFDM symbol in a frequency domain, which is FFT-processed by the channel estimation vector by synchronization with the start OFDM symbol of the preamble.

The received signal of the communication system may include a physical layer link channel (PLC) stream of a data over cable service specification (DOCSIS) system.

The processing unit may include 128 OFDM symbols, the one OFDM symbol length may be a 4K-FFT mode constituted by 3800 subcarriers, and the one OFDM symbol length may be an 8K-FFT mode constituted by 7600 subcarriers.

The scattered pilots may be disposed by moving by one subcarrier location with an increase or decrease of an OFDM symbol number and disposed at different subcarrier locations throughout the processing unit of OFDM symbol, and the continuous pilots may be disposed at the same subcarrier location with respect to all OFDM symbols. When the scattered pilot location and the continuous pilot location overlap with each other, it is regarded that the continuous pilot is disposed at a corresponding location.

Another exemplary embodiment of the present invention provides a channel estimation and equalization apparatus based on pilot signals, including: a signal extracting unit extracting subcarrier values at a scattered pilot location and a continuous pilot location for each OFDM symbol with respect to predetermined processing unit of OFDM symbols from an OFDM symbol where a preamble of a received signal of a communication system starts; a symbol channel estimation value calculating unit calculating a channel estimation value acquired by dividing the scattered pilot subcarrier value at the scattered pilot location by a transmission scattered pilot subcarrier value to calculate a channel estimation vector constituted by an OFDM symbol channel estimation value for each processing unit of OFDM symbol; an entire channel estimation vector calculating unit calculating a channel estimation vector constituted by channel estimation values at all subcarrier locations of a length of one OFDM symbol by using the OFDM symbol channel estimation value at the scattered pilot location and the channel estimation value at the continuous pilot location included in any one OFDM symbol; and a channel equalizing unit performing channel equalization by dividing a received OFDM symbol in a frequency domain, which is FFT-processed, by the channel estimation vector by synchronization with the start OFDM symbol of the preamble.

According to exemplary embodiments of the present invention, in an apparatus and a method of channel estimation and equalization based on a pilot signal for a DOCSIS system receiver, provided is a new channel estimation and channel equalization method optimized for a system, which is low in complexity in terms of hardware implementation while securing a capability sufficient to compensate for distortion which occurs in a cable transmission channel which is not almost changed depending on a time by reliable channel estimation by using scattered pilots and continuous pilots in a DOCSIS system receiver.

In particular, since the channel estimation and channel equalization technology proposed in the present invention requires only a data memory having a length of one OFDM symbol in calculating a channel estimation vector, the size of the memory which is required in the hardware implementation is much smaller than the related art, and as a result, it is very advantageous from the viewpoint of complexity and power consumption of a chip in terms of receiver implementation. Therefore, the proposed method can provide a simple hardware structure at the time of implementing a channel estimation and equalization apparatus of a DOCSIS system, and as a result, it is expected that utilization for developing the DOCSIS down stream receiver will be high.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram for describing a 4K-FFT mode scattered pilot pattern in a general DOCSIS 3.1 Down Stream system.

FIG. 2 is a diagram for describing an 8K-FFT mode scattered pilot pattern in the general DOCSIS 3.1 Down Stream system.

FIG. 3 illustrates an example of 4K-FFT mode scattered pilot and continuous pilot patterns in a DOCSIS system of the present invention.

FIG. 4 illustrates an example of 8K-FFT mode scattered pilot and continuous pilot patterns in the DOCSIS system of the present invention.

FIG. 5 is a diagram for describing a transmitter and a receiver of a DOCSIS system according to an exemplary embodiment of the present invention.

FIG. 6 is a diagram for describing a channel estimation and equalization apparatus based on pilot signals in a receiver of a DOCSIS system according to an exemplary embodiment of the present invention.

FIG. 7 is a flowchart for describing an operation of the channel estimation and equalization apparatus of FIG. 6.

FIG. 8 is a diagram illustrating a relationship between an OFDM symbol and a pilot in a 4K-FFT mode for describing a channel estimation vector calculating process of FIG. 6.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the exemplary drawings. When reference numerals refer to components of each drawing, it is noted that although the same components are illustrated in different drawings, the same components are designated by the same reference numerals as much as possible. In describing the exemplary embodiments of the present invention, when it is determined that the detailed description of the known components and functions related to the present invention may obscure understanding of the exemplary embodiments of the present invention, the detailed description thereof will be omitted.

Terms such as first, second, A, B, (a), (b), and the like may be used in describing the components of the exemplary embodiments of the present invention. The terms are only used to distinguish a component from another component, but nature or an order of the component is not limited by the terms. Further, if it is not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

First, a scattered pilot pattern used in a cable interface communication system such as a DOCSIS 3.1 Down Stream System shows a little difference according to 4K-FFT and 8K-FFT according to a fast Fourier transform (FFT) mode.

<4K-FFT Mode Scattered Pilot Pattern>

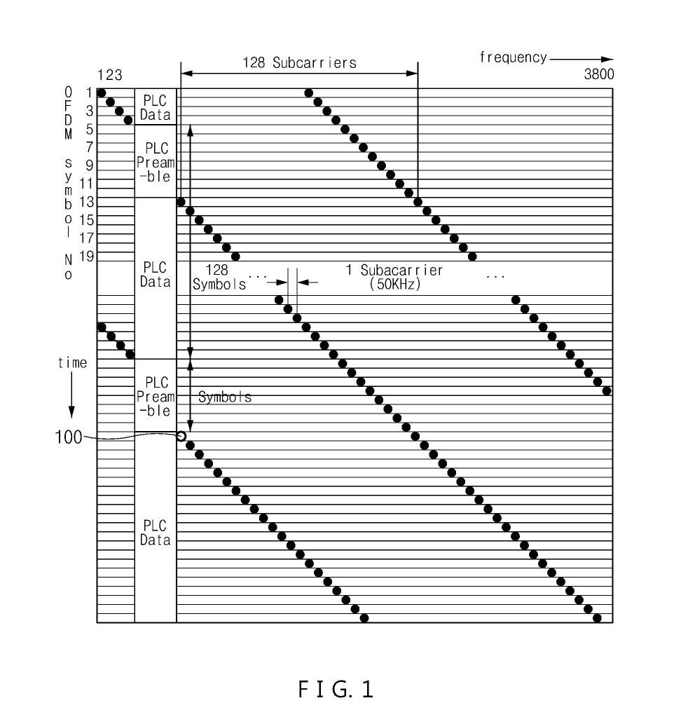

FIG. 1 is a diagram for describing a 4K-FFT mode scattered pilot pattern in a general DOCSIS 3.1 Down Stream system.

A 4K-FFT mode scattered pilot is disposed in the same pattern in which OFDM symbols disposed by moving by 1 subcarrier location are scattered to each of 128 OFDM symbols among the OFDM symbols and repeatedly disposed by using an OFDM symbol in which a physical layer link channel (PLC) preamble starts as a start OFDM symbol as illustrated in FIG. 1.

That is, based on a just next subcarrier (100 location) in which a physical layer link channel (PLC) preamble subcarrier ends, which is a #9 OFDM symbol (100) location from a location where the PLC preamble starts, the scattered pilots are disposed by moving by one subcarrier location in a high-frequency direction when an OFDM symbol number increases, and the scattered pilots are disposed by moving by one subcarrier location in a low-frequency direction when the OFDM symbol number decreases. The scattered pilots are scattered and disposed in every 128 subcarriers in directions in which a frequency increases and decreases based on a reference subcarrier (100 location) of the #9 OFDM symbol (100) location. For example, the scattered pilots are present while moving one subcarrier location in a direction in which a frequency value increases whenever the OFDM symbol number increases up to the #128 OFDM symbol from the #9 OFDM symbol based on the immediately next subcarrier (100 location) where the subcarrier of the PLC preamble ends in the #10 to #128 OFDM symbols. On the contrary, the scattered pilots are present while moving one subcarrier location in the direction in which the frequency value decreases whenever the OFDM symbol number decreases based on the reference subcarrier (100 location) in the #1 to #8 OFDM symbols.

The scattered pilots may not be present at the subcarrier location where the PLC subcarrier is present and when the location of the scattered pilot and the location of the continuous pilot overlap with each other, the overlapped pilots are regarded as the continuous pilots.

<8K-FFT Mode Scattered Pilot Pattern>

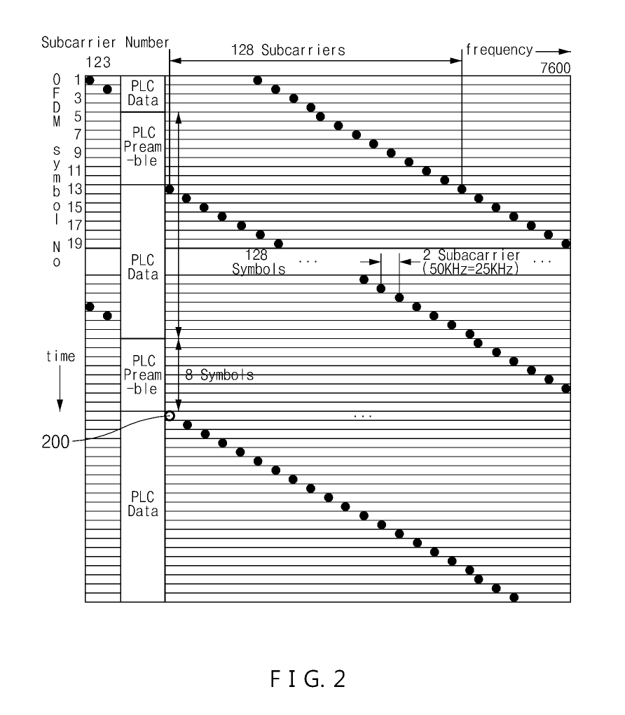

FIG. 2 is a diagram for describing an 8K-FFT mode scattered pilot pattern in the general DOCSIS 3.1 Down Stream System.

In an 8K-FFT mode, a reference point of a scattered pilot layout is a immediately next subcarrier location (200 location) where the preamble subcarrier ends, which is the #9 OFDM symbol (200) location as illustrated in FIG. 2 and when the OFDM symbol number increases based on the subcarrier, the scattered pilots are disposed by moving by 2 subcarrier locations in the direction in which the frequency increases and when the OFDM symbol number decreases, the scattered pilots are disposed by moving by 2 subcarrier locations in the direction in which the frequency decreases.

That is, the scattered pilots are disposed in every 128 subcarriers in the directions in which the frequency increases and decreases based on a scattered pilot layout reference subcarrier (200 location) of the #9 OFDM symbol (100) location. In the #1 to #8 OFDM symbols, the scattered pilots are disposed by moving 2 subcarrier locations in the direction in which the frequency decreases whenever the OFDM symbol number decreases up to the #1 OFDM symbol based on the reference subcarrier (200 location) of the scattered pilot layout. In addition, in the #10 to #128 OFDM symbols, the scattered pilots are disposed by moving by 2 subcarrier locations in the direction in which the frequency value increases whenever the OFDM symbol number increases up to the #128 OFDM symbol based on the reference subcarrier.

However, when the scattered pilots are disposed as described above, a subcarrier location where the scattered pilot is not present with respect to 128 selected OFDM symbols may be present, and as a result, a channel estimation capability may deteriorate. In order to avoid deterioration of the channel estimation capability, the 8K-FFT mode is divided into two groups of 64 OFDM symbols of #1 to #64 and 64 OFDM symbols of #65 to #128, and with respect to the first group of 64 OFDM symbols and the second group of 64 OFDM symbols, only one subcarrier moves immediately next to the first group of the 64 OFDM symbols, and as a result, the second group of 64 OFDM symbols is disposed. That is, one subcarrier interval is present between the first group of 64 OFDM symbols and the second group of 64 OFDM symbols.

When the scattered pilots are disposed such that two groups of 64 OFDM symbols deviate from each other by one subcarrier location, the scattered pilots are supplemented in the second OFDM symbol group even though there is a location where the scattered pilots are not present at the subcarrier locations of the first 64 OFDM symbol group, and as a result, the scattered pilots are present at all subcarrier locations throughout 128 OFDM symbols and reliable channel estimation is available at all subcarrier locations.

The scattered pilots may not be present at the subcarrier location where the PLC subcarrier is present and when the location of the scattered pilot and the location of the continuous pilot overlap with each other, the overlapped pilots are regarded as the continuous pilots.

<PLC Structure>

The PLC is constituted by a PLC preamble and PLC data in both the 4K-FFT mode and the 8K-FFT mode. The PLC preamble is constituted by 8 OFDM symbols and the PLC data is constituted by 120 OFDM symbols. The PLC preamble is repeated with a period of 128 OFDM symbols.

<Analysis of Applicability of Conventional Channel Equalization Method to DOCSIS 3.1 Down Stream System>

In the general channel equalization method, first, time domain channel estimation is performed to acquire the channel estimation vector at the corresponding subcarrier location with respect to OFDM symbols which are present between two OFDM symbols in which the pilot is present at the same subcarrier location. After acquiring the time domain channel estimation vector as described above, channel estimation vectors at all subcarrier locations are acquired for each OFDM symbol by applying frequency domain channel estimation. In channel equalization, a received signal is divided by the channel estimation vector acquired as such to acquire a signal in which channel distortion is compensated.

The DOCSIS 3.1 Down Stream system has a feature in which the scattered pilot pattern is repeated every 128 OFDM symbols. On the contrary, the continuous pilot is a scheme in which all OFDM symbols are disposed at the same subcarrier location. When the conventional channel equalization method is applied to the receiver of the DOCSIS 3.1 Down Stream System, the pilots need to be present at both specific subcarrier locations in the time domain channel estimation. Since the same scattered pilot pattern is repeated every 128 OFDM symbols, the DOCSIS 3.1 Down Stream System is shown after 128 OFDM symbols based on a current OFDM symbol in order to make the pilot be present at the same subcarrier location. Therefore, in order to apply the conventional time domain channel estimation method, as the received signal, 128 OFDM symbols are stored and channel estimation vectors of 128 OFDM symbols corresponding to 128 received OFDM symbols are stored and a storage space is required, which is capable of storing 128 channel equalization output OFDM symbol signals acquired by dividing the received signal by the channel estimation vector.

When 4096QAM modulation is applied, subcarriers of all OFDM symbols have 4096QAM modulated signals, and in the 4K-FFT mode, 3800 4096QAM modulated subcarriers are present and in the 8K-FFT mode, 7600 4096QAM modulated subcarriers are present. The 4096QAM modulated signals have a size of at least 14 bits (2¹⁴=4096) and in general, 20 bits are applied by considering precision of signal processing. When the conventional channel estimation method is applied, each of the received signal, the channel estimation vector, and the channel equalizer output signal needs to have a length of at least 128 OFDM symbols. Therefore, in the hardware implementation, since 3800 subcarriers are present in the 4K-FFT mode, 3 memories having a size of 128*3800*20=approximately 9.7 Mbits are required, and as a result, a memory having a size of approximately 29 Mbits is required and since 7600 subcarriers are present in the 8K-FFT mode, 3 memories having a size of 128*7600*20=approximately 19 Mbits are required, and as a result, a memory having a size of approximately 58 Mbits is required. Since the receiver of the DOCSIS 3.1 Down Stream system needs to support both the 4K-FFT mode and the 8K-FFT mode, a memory having approximately 58 Mbits or more is primarily required, and as a result, a chip of the DOCSIS 3.1 Down Stream receiver also requires a very large memory having approximately 58 Mbits. Therefore, it is actually impossible to apply the general channel estimation and channel equalization method to the receiver of the DOCSIS 3.1 Down Stream System.

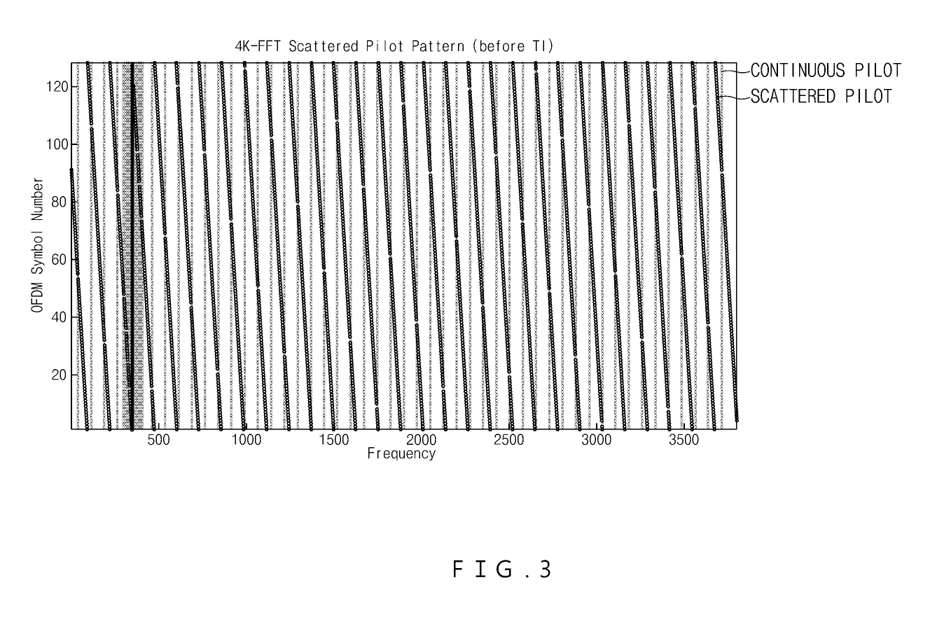

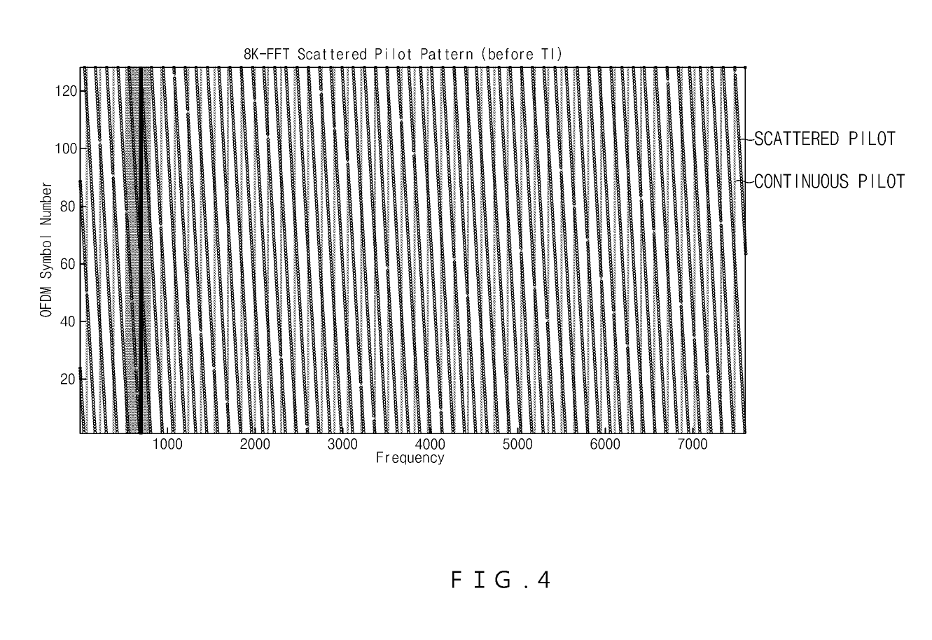

Meanwhile, in the channel estimation and equalization method based on the pilot in a DOCSIS 3.1 down stream PHY system (briefly, the DOCSIS system or cable interface system) of the present invention, as a method optimized for a pilot pattern characteristic, both the scattered pilot and the continuous pilot which are present in the DOCSIS 3.1 Down Stream system are used. As illustrated in FIGS. 3 and 4, the scattered pilots are present at different subcarrier locations throughout 128 OFDM symbols and the continuous pilots are disposed at the same subcarrier location with respect to all OFDM symbols.

That is, in the channel estimation and equalization method based on the pilot in the DOCSIS system of the present invention, in transmitting/receiving the OFDM symbol by using the multiple carriers, the channel estimation vector may be acquired and the channel equalization may be effectively performed by using the scattered pilots and the continuous pilots. Complexity can be significantly enhanced in terms of hardware implementation compared to the related art because the hardware implementation is very simple while securing a capability sufficient to compensate for distortion which occurs in a cable transmission channel which is not almost changed depending on a time by reliable channel estimation through a channel estimation and channel equalization method optimized for scattered pilot and continuous pilot patterns of a down stream in a DOCSIS system of the present invention.

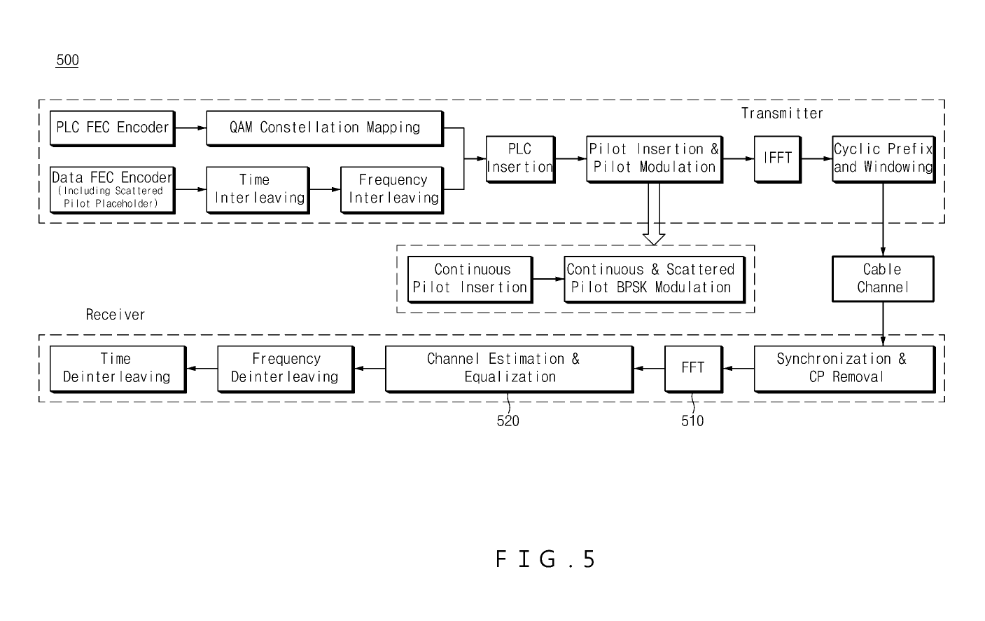

FIG. 5 is a diagram for describing a transmitter and a receiver of a DOCSIS system 500 according to an exemplary embodiment of the present invention.

Referring to FIG. 5, the transmitter of the DOCSIS system 500 according to the exemplary embodiment of the present invention includes a PLC forward error correction (FEC) encoder, a quadrature amplitude modulation (QAM) constellation mapping unit, a data forward error correction (FEC) encoder including a scattered pilot placeholder, a time interleaving unit, a frequency interleaving unit, a PLC insertion unit (performing continuous pilot and scattered pilot binary phase shift keying (BPSK) modulation through inserting the continuous pilot), an inverse FFT (IFFT) unit, a cyclic prefix and windowing unit, and the like.

The transmitter of the DOCSIS system 500 may transmit the OFDM symbol in the 4K-FFT mode or the 8K-FFT mode and the receiver of the DOCSIS system 500 according to the exemplary embodiment of the present invention, which is connected with the transmitter of the DOCSIS system 500 through a cable channel depending on a DOCSIS 3.1 protocol, and the like includes a synchronization and cyclic prefix (CP) removal unit, an FFT unit 510, a pilot based channel estimation and equalization apparatus 520, a frequency deinterleaving unit, a time deinterleaving unit, and the like.

Since the structures of the transmitter and the receiver of the DOCSIS system 500 are well known, a detailed description of the components will be omitted.

In particular, in a pilot based channel estimation and equalization apparatus 520 of the receiver of the DOCSIS system 500, in receiving the OFDM symbol by using the multiple carriers, the channel estimation vector may be acquired and the channel equalization may be effectively performed by using the scattered pilots and the continuous pilots. Further, complexity can be significantly enhanced in terms of hardware implementation compared to the related art because the hardware implementation is very simple while securing a capability sufficient to compensate for distortion which occurs in a cable transmission channel which is not almost changed depending on a time by reliable channel estimation through a channel estimation and channel equalization method optimized for scattered pilot and continuous pilot patterns of the down stream.

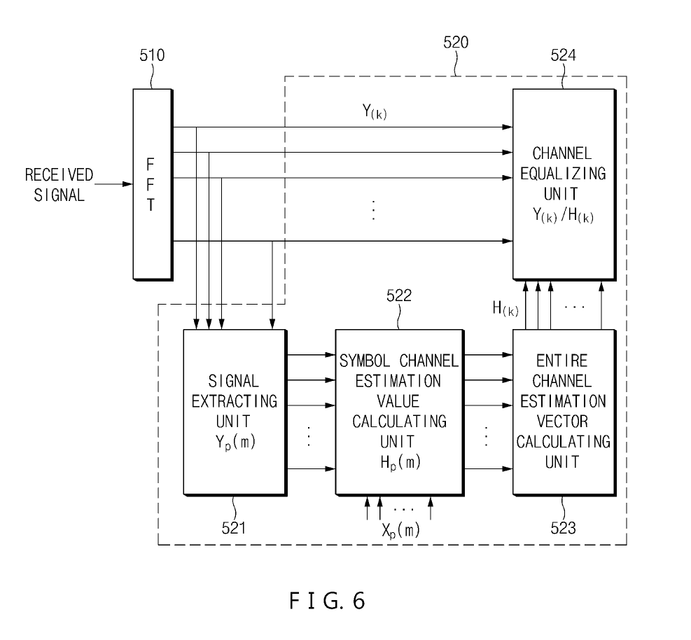

FIG. 6 is a diagram for describing a channel estimation and equalization apparatus 520 based on pilot signals in a receiver of a DOCSIS system 500 according to an exemplary embodiment of the present invention.

Referring to FIG. 6, the channel estimation and equalization apparatus 520 based on pilot signals in the receiver of the DOCSIS system 500 according to the exemplary embodiment of the present invention includes a signal extracting unit 521, a first channel estimating unit 522, a second channel estimating unit 523, and a channel equalizing unit 524.

First, functions of the components of the channel estimation and equalization apparatus 520 based on pilot signals according to the present invention will be described in brief

The signal extracting unit 521 extracts signals (subcarrier values) at a scattered pilot location and a continuous pilot location for each OFDM symbol with respect to predetermined processing unit OFDM symbols (128 OFDM symbols) from an OFDM symbol where a PLC preamble of a received signal of the DOCSIS system 500 starts.

A symbol channel estimation value calculating unit 522 calculates a channel estimation value acquired by dividing the scattered pilot subcarrier value at the scattered pilot location by a transmission scattered pilot subcarrier value to calculate a channel estimation vector constituted by an OFDM symbol channel estimation value for each processing unit of 128 OFDM symbols.

An entire channel estimation vector calculating unit 523 calculates a channel estimation vector constituted by channel estimation values at all subcarrier locations of a length of one OFDM symbol by using the OFDM symbol channel estimation value at the scattered pilot location and the channel estimation value at the continuous pilot location included in any one OFDM symbol.

The channel equalizing unit 524 performs channel equalization by dividing a received OFDM symbol in a frequency domain, which is FFT-processed, by the channel estimation vector by synchronization with the start OFDM symbol of the PLC preamble.

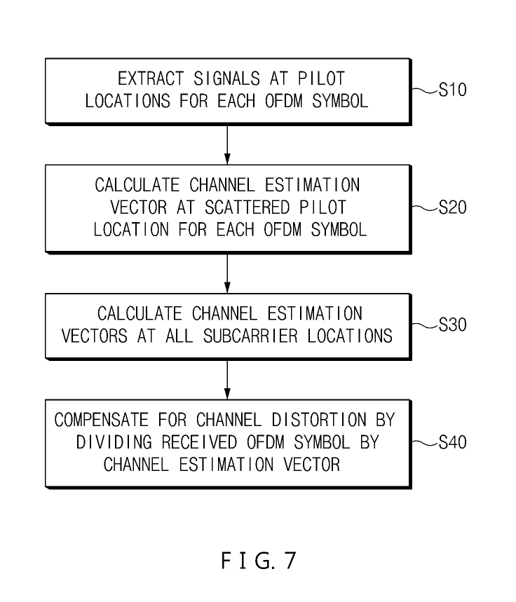

FIG. 7 is a flowchart for describing an operation of the channel estimation and equalization apparatus 520 of FIG. 6.

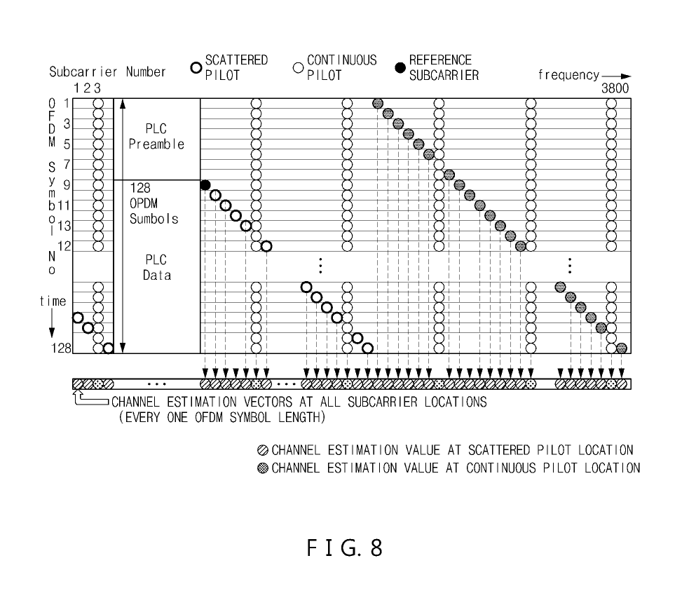

The receiver of the DOCSIS system 500 according to the exemplary embodiment of the present invention may receive a PLC stream (OFDM symbol) in the 4K-FFT mode or 8K-FFT mode depending on the DOCSIS protocol, and the like from the transmitter of the DOCSIS system 500 as illustrated in FIG. 5 through a cable channel and in the pilot based channel estimation and equalization apparatus 520, in order to process an FFT-processed received signal (symbol signal) Y(k) in the frequency domain, which is input through processing of the synchronization and cyclic prefix (CP) removal unit and the FFT unit 510 and output the processed received signal to the subsequent deinterleaving unit, first, the signal extracting unit 521 extracts signals at OFDM symbol pilot locations from the FFT-processed received signal. The signal extracting unit 521 extracts signals (subcarrier values) at the scattered pilot (SP) and continuous pilot (CP) locations included in the OFDM symbols for each OFDM symbol with respect to 128 OFDM symbols (see FIG. 8) from the OFDM symbol where the physical layer link channel (PLC) preamble starts (S10). Such a process is repeated for every 128 OFDM symbols.

When OFDM symbol signals, Yₚ(m) at the respective pilot locations are extracted for every 128 OFDM symbols, the symbol channel estimation value calculating unit 522 calculates a channel estimation value Hₚ(m) acquired by dividing the scattered pilot subcarrier value Yₚ(m) which is the subcarrier value at the scattered pilot location by the transmission scattered pilot subcarrier value Xₚ(m) as shown in [Equation 1] for each OFDM symbol to calculate a channel estimation vector constituted by the OFDM symbol channel estimation value for every 128 OFDM symbols (S20).

Hₚ(m)=Yₚ(m)/Xₚ(m) [Equation 1]

The entire channel estimation vector calculating unit 523 calculates a channel estimation vector H(k) constituted by channel estimation values at all subcarrier locations of one OFDM symbol length (3800 subcarriers in the 4K-FFT mode and 7600 subcarriers in the 8K-FFT mode) as illustrated in FIG. 8 by using the OFDM symbol channel estimation value at the scattered pilot location and the channel estimation value at the continuous pilot subcarrier location included in any one OFDM symbol from the symbol channel estimation value calculating unit 522 every 128 OFDM symbols (S30). This means that the size of a memory for storing data, which is required to acquire the channel estimation vector H(k) is remarkably reduced to the length corresponding to one OFDM symbol, and as a result, there is no problem in view of the memory for storing data while implementing hardware.

That is, with respect to 128 OFDM symbols, the OFDM symbol channel estimation values at the scattered pilot locations from the symbol channel estimation value calculating unit 522 are added with respect to the respective subcarrier locations as shown in [Equation 2] so that the channel estimation value at the continuous pilot subcarrier location is calculated with a value acquired by dividing the received continuous pilot subcarrier value at the continuous pilot subcarrier location included in any one OFDM symbol by the transmitted continuous pilot value to be substituted with the channel estimation value at the continuous pilot subcarrier location with respect to the continuous pilot location, thereby calculating the channel estimation vector H(k) constituted by the channel estimation values at all subcarrier locations of a length of one OFDM symbol (3800 subcarriers in the 4K-FFT mode and 7600 subcarriers in the 8K-FFT mode).

The channel equalizing unit 524 performs channel equalization by dividing the received OFDM symbol Y(k) in the frequency domain, which is FFT-processed, by the channel estimation vector H(k) calculated by the entire channel estimation vector calculating unit 523 through synchronization with the start OFDM symbol of the PLC preamble to compensate for channel distortion (S40).

As described above, the pilot based channel estimation and equalization apparatus 520 of the receiver of the DOCSIS system 500 according to the present invention may provide a new channel estimation and channel equalization method which is capable of estimating the channel reliably by using scattered pilots and continuous pilots and is optimized for a system to be low in complexity in terms of hardware implementation while securing a capability sufficient to compensate for distortion which occurs in a cable transmission channel which is not almost changed depending on a time. In particular, since the channel estimation and channel equalization technology proposed in the present invention requires only a data memory having a length of one OFDM symbol in calculating a channel estimation vector, the size of the memory which is required in the hardware implementation is much smaller than the related art and as a result, it is very advantageous from the viewpoint of complexity and power consumption of a chip in terms of receiver implementation. Therefore, the proposed method can provide a simple hardware structure at the time of implementing a channel estimation and equalization apparatus of a DOCSIS system, and as a result, it is expected that utilization of developing the method for developing the DOCSIS down stream receiver will be high.

The above description just illustrates the technical spirit of the present invention and various modifications and transformations can be made by those skilled in the art without departing from an essential characteristic of the present invention.

Accordingly, the exemplary embodiments disclosed herein are intended to not limit but describe the technical spirit of the present invention but the scope of the technical spirit of the present invention is not limited by the exemplary embodiments. The scope of the present invention should be interpreted by the appended claims and all technical spirit in the equivalent range thereto should be interpreted to be embraced by the claims of the present invention.

What is claimed is:

1. A channel estimation and equalization method based on pilot signals, the method comprising:
extracting subcarrier values at a scattered pilot location and a continuous pilot location for each OFDM symbol with respect to predetermined processing unit of OFDM symbols from an OFDM symbol where a preamble of a received signal of a communication system starts;
calculating a channel estimation value acquired by dividing the scattered pilot subcarrier value at the scattered pilot location by a transmission scattered pilot subcarrier value to calculate a channel estimation vector constituted by an OFDM symbol channel estimation value for each processing unit of OFDM symbol;
calculating a channel estimation vector constituted by channel estimation values at all subcarrier locations of a length of one OFDM symbol by using the OFDM symbol channel estimation value at the scattered pilot location and the channel estimation value at the continuous pilot location included in any one OFDM symbol; and
performing channel equalization by dividing a received OFDM symbol in a frequency domain, which is FFT-processed, by the channel estimation vector by synchronization with the start OFDM symbol of the preamble.

2. The method of claim 1, wherein the received signal of the communication system includes a physical layer link channel (PLC) stream of a data over cable service specification (DOCSIS) system.

3. The method of claim 1, wherein the processing unit includes 128 OFDM symbols.

4. The method of claim 1, wherein the one OFDM symbol length is a 4K-FFT mode constituted by 3800 subcarriers.

5. The method of claim 1, wherein the one OFDM symbol length is a 8K-FFT mode constituted by 7600 subcarriers.

6. The method of claim 1, wherein the scattered pilots are disposed by moving by one subcarrier location with an increase or decrease of an OFDM symbol number, disposed at different subcarrier locations throughout the processing unit of OFDM symbol, and the continuous pilots are disposed at the same subcarrier location with respect to all OFDM symbols.

7. The method of claim 6, wherein when the scattered pilot location and the continuous pilot location overlap with each other, the continuous pilot is disposed at a corresponding location.

8. A channel estimation and equalization apparatus based on pilot signals, the apparatus comprising:
a signal extracting unit extracting subcarrier values at a scattered pilot location and a continuous pilot location for each OFDM symbol with respect to predetermined processing unit of OFDM symbols from an OFDM symbol where a preamble of a received signal of a communication system starts;
a symbol channel estimation value calculating unit calculating a channel estimation value acquired by dividing the scattered pilot subcarrier value at the scattered pilot location by a transmission scattered pilot subcarrier value to calculate a channel estimation vector constituted by an OFDM symbol channel estimation value for each processing unit of OFDM symbol;
an entire channel estimation vector calculating unit calculating a channel estimation vector constituted by channel estimation values at all subcarrier locations of a length of one OFDM symbol by using the OFDM symbol channel estimation value at the scattered pilot location and the channel estimation value at the continuous pilot location included in any one OFDM symbol; and
a channel equalizing unit performing channel equalization by dividing a received OFDM symbol in a frequency domain, which is FFT-processed, by the channel estimation vector by synchronization with the start OFDM symbol of the preamble.

9. The apparatus of claim 8, wherein the received signal of the communication system includes a physical layer link channel (PLC) stream of a data over cable service specification (DOCSIS) system.

10. The apparatus of claim 8, wherein the processing unit includes 128 OFDM symbols.

11. The apparatus of claim 8, wherein the one OFDM symbol length is a 4K-FFT mode constituted by 3800 subcarriers.

12. The apparatus of claim 8, wherein the one OFDM symbol length is a 8K-FFT mode constituted by 7600 subcarriers.

13. The apparatus of claim 8, wherein the scattered pilots are disposed by moving by one subcarrier location with an increase or decrease of an OFDM symbol number, disposed at different subcarrier locations throughout the processing unit of OFDM symbol, and the continuous pilots are disposed at the same subcarrier location with respect to all OFDM symbols.

14. The apparatus of claim 13, wherein when the scattered pilot location and the continuous pilot location overlap with each other, the continuous pilot is disposed at a corresponding location.
